(19) United States
(12) Patent Application Publication
(10) Pub. No.: US 2011/0224933 A1
(43) Pub. Date: Sep. 15, 2011

(54) METHOD AND SYSTEM FOR DATA COLLECTION AND ANALYSIS TO ASSIST IN FACILITATING REGULATORY APPROVAL OF A PRODUCT

(75) Inventors: ELIZABETH E. HOOD, JONESBORO, AR (US); KELLYE A. EVERSOLE, BETHESDA, MD (US); J. DANIEL BERLEANT, LITTLE ROCK, AR (US); RICHARD S. SEGALL, JONESBORO, AR (US); ROBERT A. MUSTELL, LOUISIANA, MO (US); DEBORAH VICUNA REQUESENS, JONESBORO, AR (US)

(73) Assignee: INFINITE ENZYMES, LLC, STATE UNIVERSITY, AR (US)

(21) Appl. No.: 13/019,083

(22) Filed: Feb. 1, 2011

Related U.S. Application Data
(60) Provisional application No. 61/301,128, filed on Feb. 3, 2010.

(51) Int. Cl. G06F 19/00

(52) U.S. Cl. 702/81

(57) ABSTRACT

A method for providing a service to assist in obtaining regulatory approval of a product includes using a computing device programmed to search at least one database of literature and programmed to identify data relative to determining substantial equivalence for the product to provide a first data set. The method further includes determining experimental data to collect for the product based in part on the first data set, collecting the experimental data for the product to provide a second data set, and documenting comparative data comprising comparisons between the first data set and the second data set data indicative of substantial equivalence for the product.

### CROSS-REFERENCE TO RELATED APPLICATIONS

This application claims priority under 35 U.S.C. §119 to provisional application Ser. No. 61/301,128 filed Feb. 3, 2010, herein incorporated by reference in its entirety.

### GRANT REFERENCE

This invention was made with Government support under Grant No. 2009-33610-19721 awarded by the USDA and Grant No. EPS-0701890 awarded by the NSF. The Government has certain rights in this invention.

### FIELD OF THE INVENTION

The present invention relates to method and systems for navigating the regulatory process. More particularly, but not exclusively, the present invention relates to a service and related methods and systems for assisting in facilitating regulatory approval for products such as, but not limited to, genetically engineered transgenic specialty crops.

### BACKGROUND OF THE ART

To assist in providing background for the present invention, problems associated with obtaining regulatory approval for genetically engineered transgenic specialty crops are discussed. It is to be understood, however, that the present invention is not to be limited only to genetically engineered transgenic specialty crops, as the present invention can be applied to obtaining regulatory approval of other types of materials.

Specialty crop producers face numerous regulatory obstacles. For example, a specialty crop product from a genetically engineered crop may be required to petition the United States Department of Agriculture (USDA), the Food and Drug Administration (FDA) and/or the Environmental Protection Agency (EPA) among others to obtain non-regulated status by establishing that the specialty crop product has “substantial equivalence” to a conventional crop product. The preparation of such petitions involves numerous data intensive and costly steps.

Examples of some of the barriers facing crop developers in achieving non-regulated status for their biotechnology-derived crops include, without limitation, defining normal ranges to establish a definition of “substantial equivalence” to which the transgenic crop is to be compared, collecting relevant and complete data sets, controlling costs associated with regulatory approval, and standardization of data collection and analysis. These barriers are particularly daunting for the smaller market crop developers. Often times, novel plants are not commercialized because of significant barriers to reach non-regulated status.

What is needed is a method and system that addresses these problems to improve the efficiency of determining “substantial equivalence” and to assist in collecting comparative data for use in petitions for regulatory approval.

### SUMMARY OF THE INVENTION

Therefore, it is a primary object, feature, or advantage of the present invention to improve over the state of the art.

It is a further object, feature, or advantage of the present invention to provide a method and system for generating model regulatory approval plans for products such as, but not limited to, specialty crop products.

It is another object, feature, or advantage of the present invention to provide a service for producers of specialty crop products or others seeking regulatory approval that is cost effective.

Yet another object, feature, or advantage of the present invention is to provide a service which can be used to evaluate substantial equivalence that is efficient and cost effective.

A further object, feature, or advantage of the present invention is to directly affect the development of genetically-engineered specialty crops that address plant improvement or plant protection by providing an improved ability to move biotechnology-derived crops through the approval process for non-contained growth and non-regulated consumption of new food/feed/horticultural products.

Another object, feature, or advantage of the present invention is to provide systems, methods, or technologies that facilitate the movement (regulatory approval) of transgenic specialty crops through the existing regulatory system to reach consumer markets.

Yet another object, feature, or advantage of the present invention is to provide a program for attaining non-regulated status for genetically engineered specialty crops that maximizes the use of all potential prior information and standardizes data collection.

A still further object, feature, or advantage of the present invention is to assist crop developers to gain non-regulated status (such as from the USDA's Animal and Plant Health Inspection Service (APHIS)) and registration permits (such as from the EPA for pesticidal products), and complete the voluntary consultation process with the FDA for genetically engineered (GE) specialty crops.

One or more of these and/or other objects, features, or advantages of the present invention will become apparent from the specification and claims that now follow. No single embodiment of the present invention need exhibit each and every object, feature, or advantage discussed herein.

According to one aspect of the present invention, a method is provided for a service that assists in providing regulatory approval of a product. The method includes using a computing device programmed to search at least one database of literature and programmed to identify data relative to determining substantial equivalence for the product to provide a first data set. The method further includes determining experimental data to collect for the product based in part on the first data set, collecting the experimental data for the product to provide a second data set, and documenting comparative data comprising comparisons between the first data set and the second data set data indicative of substantial equivalence for the product.

According to another aspect of the present invention, a method is provided for a service that assists in providing regulatory approval of a product. The method includes providing a web site stored on a web server, the web site providing for secure access to clients, receiving at the web site information about a product that a client seeks regulatory approval of, and using a computing device programmed to search at least one database of literature and programmed to identify data relative to determining substantial equivalence for the product to provide a first data set. The method further includes receiving at the web site the experimental data for the product to provide a second data set, generating comparative data by making comparisons between the first data set and the second data set data indicative of substantial equivalence for the product, and compiling a document comprising data for submission to a regulatory body using the comparative data.

According to another aspect of the present invention, a method for providing a service to assist in scientific documentation of at least one product is provided. The method includes using a computing device programmed to search at least one database of literature and programmed to identify data relative to determining substantial equivalence for the at least one product to provide a first data set, determining experimental data to collect for the at least one product based in part on the first data set, collecting the experimental data for the at least one product to provide a second data set, and documenting comparative data comprising comparisons between the first data set and the second data set data indicative of substantial equivalence for the at least one product to provide the scientific documentation.

### BRIEF DESCRIPTION OF THE DRAWINGS

FIG. 1A is a diagram illustrating relationships between an agricultural contract research organization and other entities.

FIG. 1B is a diagram illustrating a web-based system for providing services to clients which may include crop developers or regulatory agencies.

FIG. 2 is a flow chart indicating one example of a methodology.

FIG. 3 illustrates various stages according to one example of a methodology for mining literature and databases for data describing the variation in composition of corn seed, target protein safety and growth parameters.

FIG. 4A is a histogram of values. Each bar's height shows the number of values over some portion of the x-axis represented by its width and location. Such a histogram facilitates understanding which values are typical and which are not for a single crop characteristic.

FIG. 4B illustrates sample values of several variables shown side by side. Each bar is obtained by stacking the bars of a histogram such as that shown in FIG. 4A, end-to-end. This graph thus compactly displays the information from eight histograms in one figure.

FIG. 5 illustrates one example of a process for introducing a transgene into maize using Agrobacterium. Immature embryos from Hi II maize (a non-field variety) are co-cultivated with the Agrobacterium strain, events selected on herbicide, callus grown, somatic embryos induced, embryos germinated and plants transferred to the greenhouse.

FIG. 6 illustrates one example of a back cross program for independent transgenic events and plants. Hybrid seed is recovered throughout the breeding program to produce grain for protein isolation and analysis and for field performance data collection.

FIG. 7 illustrates one example of a file storage schema for corn and pea publications.

FIG. 8 provides a block flow diagram describing the identification of relevant numerical data from the sentences in the published literature.

FIG. 9 is a pictorial representation of a screenshot showing literature identified by the keywords “corn, maize, Zea mays” organized into tables of contents listing files with identifiers.

FIG. 10 is a pictorial representation of a screen shot showing how sentences are pulled out according to one embodiment.

FIG. 11 illustrates one example of an algorithm for ranking sentences. In the algorithm of FIG. 11, higher scores are indicative of higher potential relevance of a sentence. Note that in the algorithm sentences which include particular keywords or combinations of keywords or numeric values are given higher scores.

FIG. 12 illustrates results from applying an algorithm, which has been implemented to extract the numerical value from the sentence and place it in the data table of interest to make the numbers available for further processing, such as statistical analyses like mean and standard deviation of the characteristic in question.

FIG. 13 illustrates percent ranges and number of sentences in each range according to one example of a single crop characteristic.

FIG. 14 illustrates scores and number of sentences with each score according to one example of a single crop characteristic.

FIG. 15 illustrates sentence extraction flow from full text articles on pea. As successive query terms constrain the search, fewer sentences are identified. For the 62 sentences remaining at the end, the numbers can be extracted and analyzed.

FIG. 16 is a screenshot showing a small portion of a much longer table of tables extracted from full-text pea articles.

FIG. 17 illustrates a relatively weak query (sentences containing the terms ‘protein’ and either ‘percent’ or ‘%’, left) retrieves comparatively many sentences but fails to show a clear pattern that would be useful in extracting the actual amount of protein.

FIG. 18 illustrates a more powerfully constraining query than that used for FIG. 17 i.e., ‘protein’ and ‘content’ and either ‘percent’ or ‘%’ (in peas). Fewer sentences qualify, but of those that do, a bump in the graph appears in the expected spot, 20-30 percent for pea seed. Thus more sophisticated processing—even slightly so as in the more restrictive query shown here—produces markedly better results, illustrating that text mining is capable of performing as required.

FIG. 19 illustrates genetic background of lines compared in the field tests. SP114 and SP122 are elite inbreds that are the recurrent parents for the back crosses to the transgenic lines (BCC, BCH, BCF) and for the hybrid comparator. They were grown in two field sites in central Illinois.

FIG. 20 illustrates that seed weight shows no significant difference between transgenic lines (BCC, BCH, BCF) and for the control.

FIG. 21 illustrates that germination showed no differences between transgenic lines (BCC, BCH, BCF) and for the control.

FIG. 22 illustrates that root growth showed no significant differences although control roots appeared to be less vigorous.

FIG. 23 illustrates there were no differences observed among the transgenic or control lines from either field site as illustrated by ethanol soluble protein profiles.

### DETAILED DESCRIPTION

According to one aspect, the present invention provides for methods and systems for generating a model regulatory approval plan for a product by determining substantial equivalence.

### 1. Overview

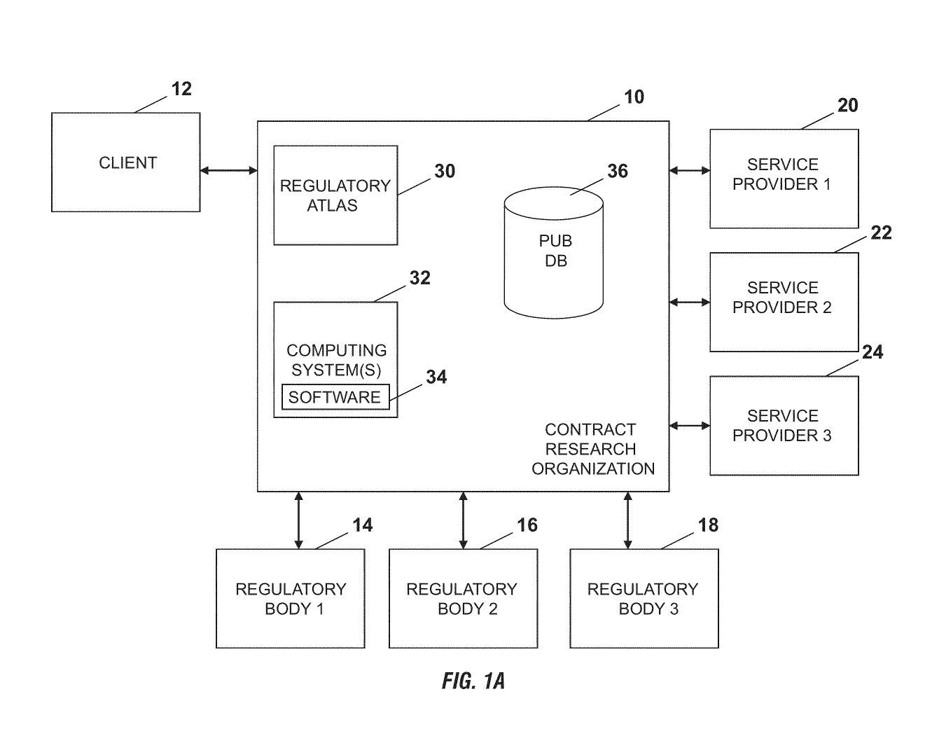

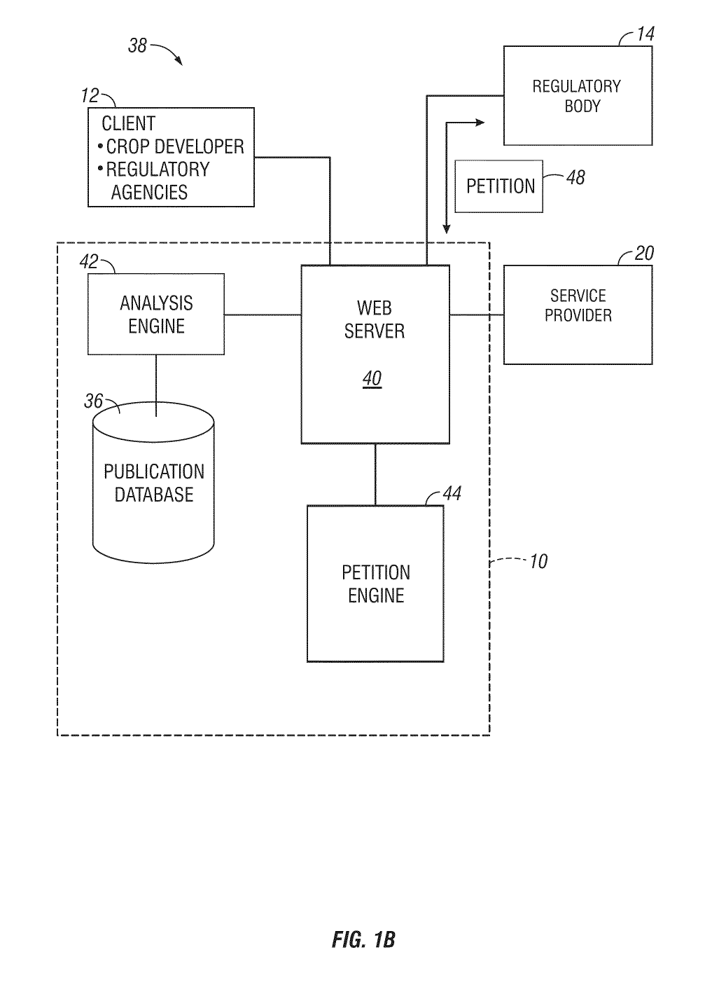

FIG. 1A provides one example of a system of the present invention. In FIG. 1A, an agricultural contract research organization (AgCRO or AgriCRO) 10 is shown which assists client(s) 12 in facilitating regulatory approval or deregulation of products associated with the client(s) 12. Examples of the types of products which client(s) 12 may seek regulatory approval or deregulation of may include transgenic specialty crop products for use as food products, pharmaceutical products, or other uses. The contract research organization 10 assists in identifying the relevant regulatory bodies 14, 16, 18 which need to provide approval and then the agricultural contract research organization 10 assists in interacting with the regulatory bodies 14, 16, 18 to assist in facilitating submissions sufficient to allow for regulatory approval.

The client(s) may include university researchers, public sector researchers, small companies and non-profits that are developing specialty crops. In addition, services may also be performed for the regulatory bodies 14, 16, 18. Such services may involve providing meta-analysis to analyze the value of data collection or performing specific research studies in various areas of relevance to the regulatory bodies 14, 16, 18.

The agricultural contract research organization 10, as will be further explained herein, uses a regulatory atlas 30 to assist in mapping out a strategy for approval. The regulatory atlas 30 may, but need not, comprise a series of flow charts or a set of questions and possible answers that, based upon the results of information provided by a client 12, indicate which of the relevant regulatory bodies 14, 16, 18 must be involved in the process and other parameters of the strategy to be employed.

The agricultural contract research organization 10 has access to a publication database 36 which may include publications and scientific literature relating to genetically regulated products. The agricultural contract research organization has software 34 stored on a computer readable storage medium and executing on a computing system(s) 32. The software 34 may provide for mining publicly available literature and databases to establish normal data which to compare with the biotechnology-derived event.

Based on an analysis of the specific data mined from the publication database 36 using the software 34, a determination is made of what experimental data for the product are needed. These experimental data are then acquired from the client 12, or alternatively, the experimental data may be acquired from one or more service providers 20, 22, 24. The agricultural contract research organization 10 may be a service provider as well and may provide laboratory services, greenhouse services and/or field testing services.

This ability to review the scientific literature as a whole assists in rapidly identifying experimental data of interest in making comparisons for substantial equivalence. The ability to quickly and efficiently determine what comparisons and experimental work should be performed provides a number of advantages. For example, it allows a more complete understanding of the resources needed for completing submissions to regulatory bodies to be determined early on in the process, allows these efforts to be appropriately budgeted for, and avoids unnecessary experimental work.

Once the agricultural contract research organization 10 has both the experimental data as well as the data acquired from the literature, the agricultural contract research organization 10 may assist the client 12 in documenting comparisons between the data and the experimental data indicative of substantial equivalence for the product. The agricultural contract research organization 10 may assist the client 12 by drafting petitions or other submissions for the appropriate regulatory bodies 14, 16, 18. It is to be understood that the agricultural contract research organization 10 and/or client 12 may be in contact with the regulatory bodies 14, 16, 18 throughout the process.

FIG. 1B illustrates one example of a web-based system of the present invention. In FIG. 1B, the system 38 includes a web server 40 associated with the agricultural contract research organization 10. The web server 40 includes one or more computers and a computer readable storage medium in which instructions for providing a web site are provided. Various users may have secure access to the web server 40 over the web in the conventional manner, with varying functionality provided to such users based on their role. Examples of users may include clients 12 which may include crop developers as well as regulatory agencies. Other users of the web site associated with the web server 40 may include regulatory bodies 14 (in a non-client capacity), or service providers 20. Other users of the web site include representatives of the contract research organization 10 who operates and maintains the system.

The web sever 40 is operatively connected to a publication analysis engine 42. The analysis engine 42 provides for analyzing publications across the Internet or stored in one or more publication databases 36 to identify data relevant to a particular crop. The analysis engine 42 may also search other types of databases as well including databases of protein, databases of DNA, or other types of public, private, or proprietary databases. The analysis engine 42 may use various algorithms for searching publications such as by searching by keywords, sentence analysis, semantic analysis, or other algorithms.

The web server 40 is also operatively connected to a petition engine 44. The petition engine 44 may provide for developing a petition, an outline of a petition, or portions of a petition based on data identified by the analysis engine 42, experimental data collected by the service providers 20, or otherwise. It is to be understood that development of a petition involves human input and analysis, and thus any petition generated or outline of a petition would be subjected to further review from the agricultural contract research organization 10 and/or client 12. A resulting petition or petition outline 48 may be electronically communicated or otherwise communicated to a regulatory body 14. It is contemplated that the regulatory body 14 may provide feedback to further refine a petition or identify additional data that may be required in order to support a grant of the petition prior to the submission of any petition. In addition, the petition or petition outline 48 may be made available on the web site to assist the client or others involved. It is further to be understood that a petition or petition outline 48 may be populated with data as data are identified in the literature or data are collected via experimentation.

Although discussed as a “petition” it is to be understood that different agencies may have other names for requests made by or on behalf of crop developers for permission or approval for a particular activity regulated by a regulating body. The term “petition” is intended to encompass such requests or other types of filings with a regulatory body. It is to be further understood that the regulatory body 14 need not necessarily be a government body but may also be another organization such as one that provides for voluntary certification.

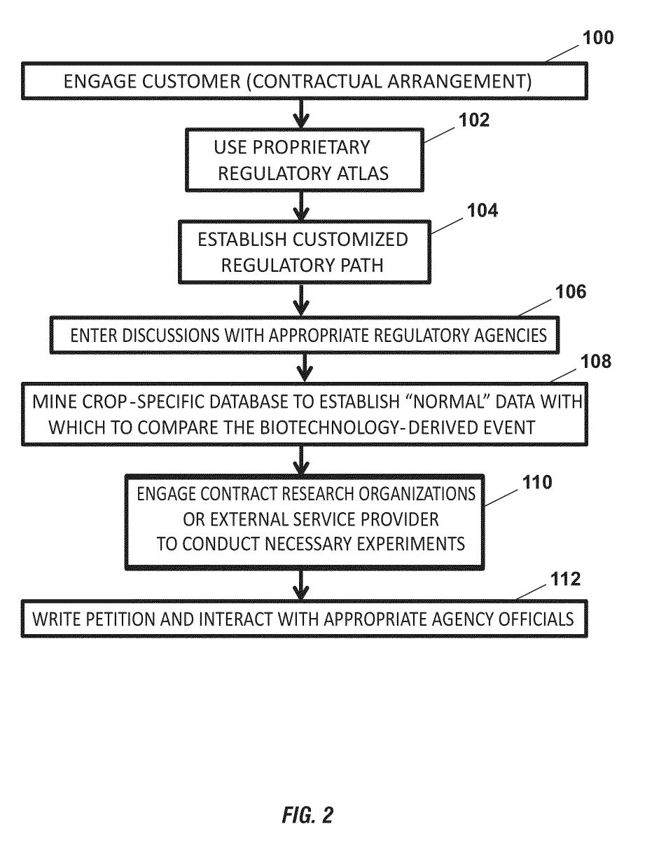

FIG. 2 illustrates one example of a method. In FIG. 2, in step 100, a customer is engaged. The customer or client may be engaged through a contractual arrangement. The customer may be a small business, educational or research institution or other entity which has developed or has rights to a product which they desire to deregulate or receive regulatory approval for in order to commercialize.

Next, in step 102, a regulatory atlas is used to assist in mapping out a strategy. The regulatory atlas may comprise a plurality of flow charts or other information to assist in determining which regulatory agencies may be involved and the process to use in moving towards deregulation or regulatory approval of a product. In step 104, a customized regulatory plan is developed. In step 106, discussions are entered with appropriate regulatory agencies. Information obtained from such discussions may be used to further guide the process.

In step 108, the crop-specific database is mined to establish normal data which to compare with the biotechnology-derived event. In step 110, the agricultural contract research organization and/or outside service providers may be engaged to conduct necessary experiments. Alternatively, the experiments could be conducted by the client. In step 112, petitions are written and there is interaction with the appropriate agency officials in order to make the necessary submissions to the appropriate regulatory bodies.

Another example of this process is that when a customer is identified, a contract will be signed. A project manager may be assigned to the customer as the first point of contact. The project manager may assist the customer on a continuing basis throughout the entire process. The business functions performed directly by the agricultural contract research organization may begin with a trip, with the customer, through the regulatory atlas. The regulatory atlas assists in guiding one through the tasks necessary for the product in question to achieve approval for growth and consumption without permits. This established path assists in determining which regulatory agencies should be involved in the petition process and the project manager may then begin by accompanying the customer on visits to the regulatory agencies to initiate discussions on the biotechnology event/product/crop combination. When a consensus is reached on the appropriate path, the database may be mined to determine the baseline of parameters for the crop in question. “Normal” parameters will be established using the mined data to which experimental data will be compared. Meta-analysis of specific parameters may be conducted to determine if crop characteristics are variable for the crop/gene combination in relation to the “wild type” or “normal” conditions determined through mining.

The project manager may then, with the customer's permission, contact appropriate research organizations to collect relevant data for the petition(s) including for example: composition, toxicology, field performance, allergenicity, feeding studies, etc. The data may be compared to the “normal” range that is determined from data mining.

Finally, a petition may be composed and presented to the appropriate regulatory agencies. This may be written either by the customer, a contracted consultant, or the project manager from the agricultural contract research organization. The project manager may be expected to accompany the customer to the regulatory agencies for petition presentation and to answer questions on process, methodology and composition.

The present invention assists in attaining biotechnology-derived specialty or non-specialty crop non-regulated status to assist in commercializing those crops. The availability of the database of literature data also allows for meta-analysis to be performed. The meta-analysis may be used by regulatory bodies or others to assist in determining the parameters of interest in determining substantial equivalence for a particular product or type of product. In addition, the meta-analysis may be used in defining or refining the regulatory roadmap.

### 2. Example: Constructing a Regulatory Plan

To assist in further explanation of the present invention, one example of constructing a regulatory plan is described in greater detail. The regulatory plan in this example is designed to achieve a determination by USDA-APHIS of “non-regulated status” for transgenic corn containing a cellulase gene. Here, the corn with cellulase would not require EPA review under current regulations; however an APHIS determination of non-regulated status would be necessary and voluntary consultation with the FDA would be advisable before the corn is released without restriction. The primary components of the regulatory plan include: the crop of interest, the gene of interest, the agencies involved, current accepted laboratory data, current accepted field data, toxicity studies, allergenicity studies, and an environmental assessment.

### 2.1 Overview

One example of using the service may be to assist in obtaining a regulatory plan for approval of a genetically engineered specialty corn product. In such a case, corn (Zea mays, L) is used as a model.

Published texts may be used to extract data about normal non-transgenic hybrid strains of corn that can be used to establish the parameters of agronomic performance. The extracted data may then be compiled into tables to establish the mean and standard deviation of “normal” characteristics such as protein content, amino acid profile and yield. A number of databases may be built using this information. The first may contain the publications identified in the searches that are related to the crop in question. The second may be the extracted data that are mined from the publications. The third may contain the data that are meta-analyzed to establish the impact of transgenes on various agronomic, food/feed, or environmental parameters. These databases may be built as separate databases or a single database.

The present invention allows for text mining and data mining of existing published or unpublished literature to establish the baseline of “normal” for the crop in question. The data acquired may also be used for other purposes. For example, meta-analysis on existing studies may be performed that address impact of genetically engineered traits on agronomic performance or the environment. These analyses may also be maintained in the database(s).

The status of the following may be assessed for the regulatory plan, and data mined to establish the “normal ranges.”
Compositional assessment from greenhouse materials
Compositional assessment of field grown materials
Protein safety assessment
Agronomic and phenotypic assessments
Environmental impact assessment

Current literature may be mined for criteria important for regulatory approval, for example, composition of seed, disease response, growth in a variety of environments, plant growth in multiple environments, agronomic and/or nutritional characteristics, etc. A number of transgenic events and progeny of this crop (Table 1) are being grown in a variety of environments and thus seed and plants are available to compare the literature data to actual plant-derived data. Analyses of these transgenic lines may be conducted including total protein, carbohydrate (starch) and oil content of seed. In addition, two dimensional gel analyses may be used to determine protein variation in samples grown in two or more environments. Collaboration with a breeder may be used for gathering data on field performance.

TABLE 1
Transgenic maize lines containing cellulase enzymes in the embryo.

| | | | | | | | Hybrid |
|---|---|---|---|---|---|---|---|
| Line | | T5 AR | T6 PR | Hybrid | T7 AR+ | T8 PR | production |
| identifier | Protein | 2008 | 2009 | AR 2009 | IL* 2009 | 2010 | 2010 |
| BCC0206 | CBH I | Multiple | Multiple | 0.8 acre | Multiple | Multiple | 2 acres |
| | | rows | rows | | rows | rows | |
| BCC0709 | CBH I | Multiple | Multiple | | Multiple | Multiple | |
| | | rows | rows | | rows | rows | |
| BCH0101 | El | Multiple | Multiple | 0.2 acre | Multiple | Multiple | 2 acres |
| | | rows | rows | | rows | rows | |
| BCF0307 | El | Multiple | Multiple | | Multiple | Multiple | |
| | | rows | rows | | rows | rows | |

Lines described in Hood et al., (2007). * Illinois Crop Improvement Association. AR=Arkansas; PR=Puerto Rico. T4-T7=fourth through seventh generation from selection of the transformation event. Maize transgenic events are generated in the Hi II corn line that is not adapted to field performance. Thus, it must be bred into elite germplasm to generate transgenic parents that are crossed to create a high-performing hybrid for production.

The present invention incorporates text and data mining techniques to identify data sets pertinent to the plant/tissue/transgene of interest. While humans are superior to computers in identifying databases and information repositories that are likely to contain the sought information, computers have a strong edge in finding key data within those repositories and in efficiently managing voluminous data (e.g. 2 articles per minute were published in 2008 (Hull et al. 2008)). The present invention contemplates that to build on the superiority of computers in the latter task by including software components that contain the information that a human would bring to bear on the problem. That information may be elicited from people on the project team and, once obtained, will be stored for repeated use by the software.

The data mined can be organized into tables and graphs that will describe ranges of variation for crop plant characteristics and novel traits that could establish boundaries for substantial equivalence.

### 2.2. Mine Literature and Databases for Data Describing the Variation in Composition of Corn Seed, Target Protein Safety and Growth Parameters

Software may be used for data mining for: compositional analysis of corn seed from multiple lines grown in the field and greenhouse; field analysis of corn plants measuring height, seed yield, disease resistance, lodging; safety of protein of interest; and/or other parameters of interest.

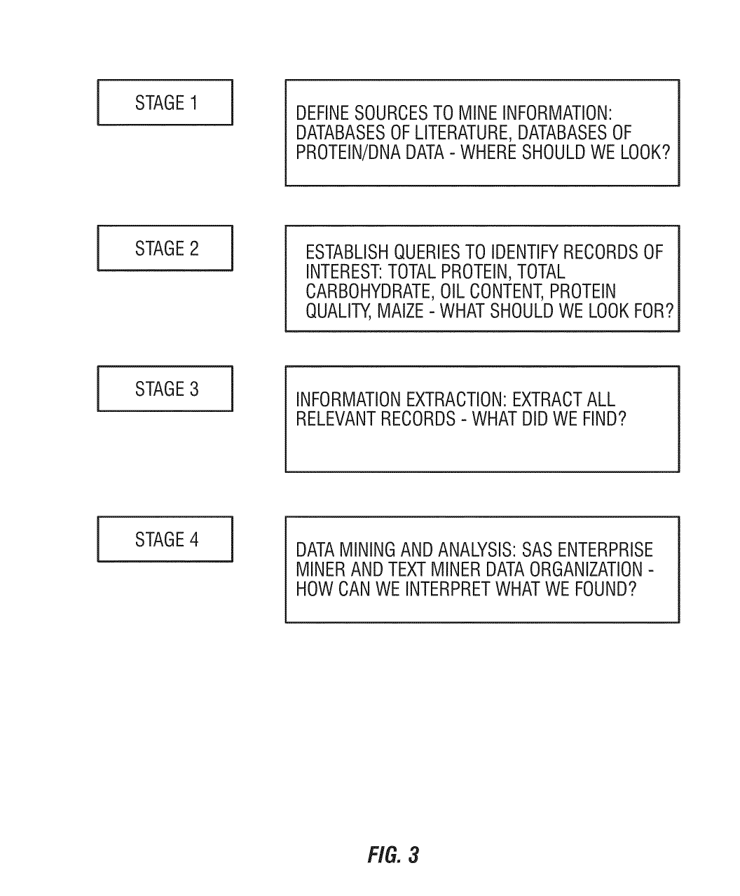

The software may use successive stages of processing. Examples of such stages are shown in FIG. 3 and described below.

Stage 1: Define sources. The first stage is a listing of information sources. These may include PubMed, PubMedCentral, Agricola, Biological Abstracts, Chemical Abstracts, NCBI, Maize Genome Database, and International Life Sciences Institute. This list of sources may be used by the software as sources of data to be mined.
Stage 2: Establish queries. A list of queries may be used for the purpose of retrieving records that may contain information useful in determining the ranges of values of those characteristics of interest to the regulatory approval of transgenic crops. The information retrieval (IR) field recognizes two conflicting objectives in developing optimal queries. One objective addresses the need to retrieve as many of the targeted records as possible, while the second addresses the need to retrieve only useful records. These conflict because inclusive queries tend to retrieve many irrelevant records, while queries formulated to exclude irrelevant records tend to also exclude some relevant ones. A balanced metric for assessing query quality is F, or effectiveness. This is the harmonic mean of the amounts of recall (R) and precision (P), which are the technical names of the two conflicting retrieval objectives just mentioned. The formula is

$$F = \frac{2}{\frac{1}{R} + \frac{1}{P}} ,$$

and can be generalized to allow giving unequal weights to recall and precision. Recall will need to be weighted more highly for specialty crops (for which fewer data are available) compared to commodity crops (for which lots of data exist).

Another issue in specifying queries is that some repositories accept queries as they are stated, while others apply a process of automatic query expansion in an attempt to intelligently improve the query to meet the needs of users better than most users would be able to do themselves. For example, the PubMed query maize promoter is automatically expanded by PubMed to
(“zea mays”[MeSH Terms] OR (“zea”[All Fields] AND “mays”[All Fields]) OR “zea mays”[All Fields] OR “maize”[All Fields]) AND (“promoter regions (genetics)”[MeSH Terms] OR (“promoter”[All Fields] AND “regions”[All Fields] AND “(genetics)”[All Fields]) OR “promoter regions (genetics)”[All Fields] OR “promoter”[All Fields])
   while the synonymous query corn promoter expands to the noticeably different
(“zea mays”[MeSH Terms] OR (“zea”[All Fields] AND “mays”[All Fields]) OR “zea mays”[All Fields] OR “corn”[All Fields] OR “callosities”[MeSH Terms] OR “callosities”[All Fields]) AND (“promoter regions (genetics)”[MeSH Terms] OR (“promoter”[All Fields] AND “regions”[All Fields] AND “(genetics)”[All Fields]) OR “promoter regions (genetics)”[All Fields] OR “promoter”[All Fields]).

Query expansion need not be used even when the information resource expands them by default, as PubMed does. Instead, queries may be specified exactly as they are desired to be executed.

The present invention contemplates that queries may be formulated in any number of ways based on the sources of information being mined and the tools being used.

Stage 3: Information extraction. Text and database records that have been retrieved need further processing to be useful. Specific data may be extracted from larger records. The data needed are those that address the specific crop plant characteristics of interest that are necessary to analyze for regulatory approval. While the field of information retrieval accesses appropriate records, the field of information extraction (IE) pulls out the needed facts from within unstructured data (like a paper or abstract) or partially structured data (like a PubMed record, which usually contains an abstract as well as other information, with numerous XML tags that provide meta-information). XML (eXtensible Markup Language) is inspired by the HTML used in ordinary Web pages and is used to embed semantic information in text, for example to indicate author names, title, abstract content, etc.
Stage 4: Text and Data mining. The necessary outcome of the text and data mining phase is the body of facts stated in the literature about desired crop characteristics. Yet the value of the body of facts thus obtained is limited by its rawness. In general, long lists of individual facts must be summarized, organized, and presented properly to realize their intrinsic value. In the present case, the data, a set of evidence consisting of individual facts identified from the literature, may be mined in a process of evidence combination to identify ranges of normal variation for crop characteristics.

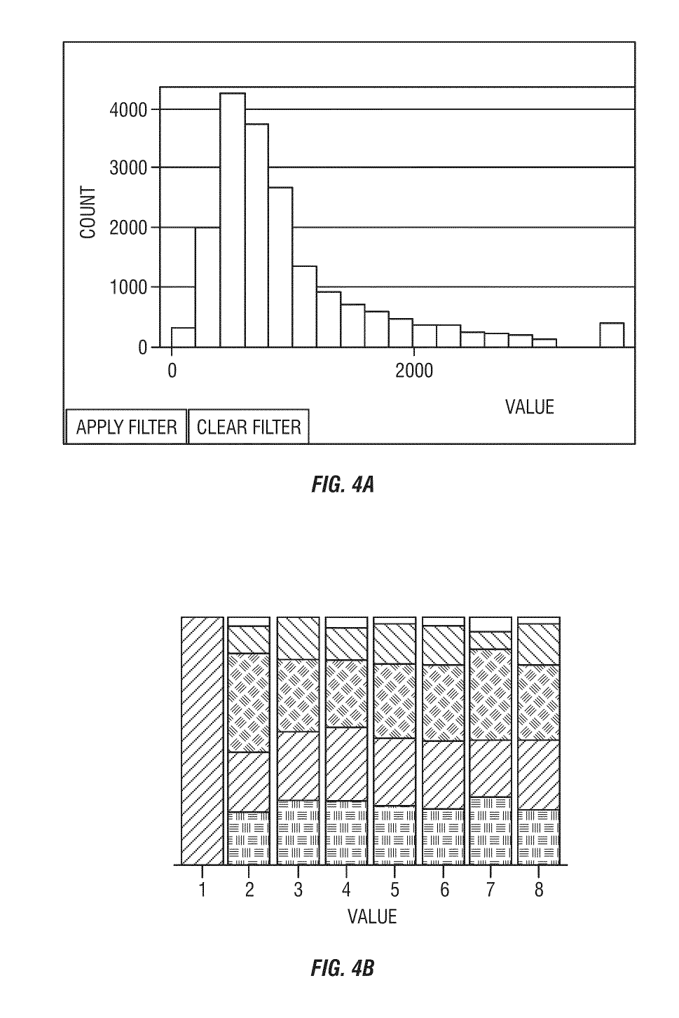

Many commercial tools can be applied to produce summarizing graphs describing sets of values, such as for a given crop characteristic. One example of such a tool is SAS Enterprise Miner (version 5.3). SAS Enterprise Miner can produce histograms of values for a given characteristic, such as shown in FIG. 4A (SAS, 2008); and can summarize a number of characteristics at once in one graph, as in FIG. 4B (SAS, 2008). It can also provide “a common framework for comparing models and predictions from any of the modeling tools, and the tool produces several charts that help to describe the usefulness of the model” (SAS 2008). Examples are shown in FIGS. 4A and 4B.

### 2.3 Collect Data

In this example, data are collected on seed composition and growth parameters for normal dent corn and transgenic corn expressing cellulases. In addition, seed composition data on #2 yellow dent corn parental and hybrid varieties may be gathered to compare to literature values for normal variation.

Shewry et al., (2007) propose that data to be collected for regulatory approval may include genomics (DNA), transcriptomics (RNA), metabolomics (small molecules), proteomics (proteins) and functional properties. Data on field performance of the plants were also collected. The application of their transgenic wheat was to improve baking quality with increased protein content. Their approach is relevant, but because they found no differences greater than those among control wheat varieties, they argued that the collection of data in all those categories was more than necessary for their application, suggesting that each petition for non-regulated status of a biotechnology-derived crop include as much relevant data but not more than is necessary to achieve confidence in the data collected.

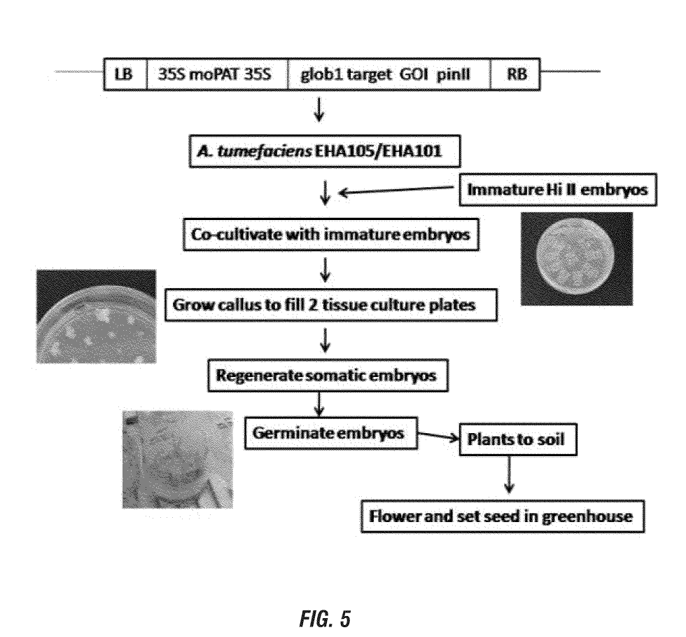

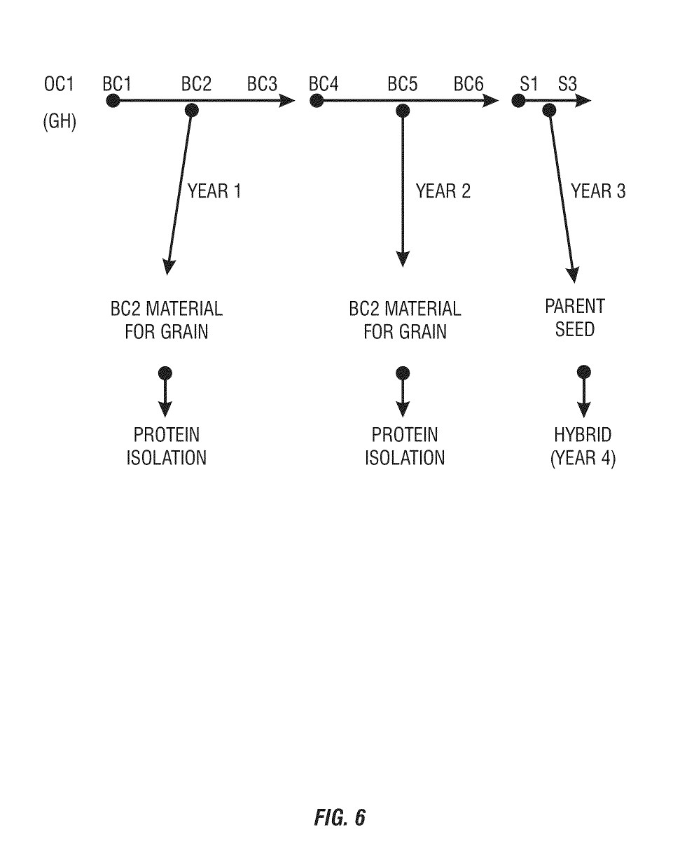

The specialty application of corn in this example is to produce cellulases for specialty market applications. Transgenic events from tissue culture (FIG. 5) are bred into elite inbred germplasm (FIG. 6) to produce corn lines that yield high quality grain in the field. These elite lines are the Stiff Stalk and Lancaster lines that are the two sides of a robust, heterotic hybrid that yields #2 yellow dent field corn. In each field where transgenic lines are grown, the hybrids and/or the inbreds are also grown as controls. These control plants will yield the grain that is used for experimental data collection for comparison with the mined data.

For example, seed compositional analysis could include:
Total protein by nitrogen analysis
Total lipid determination
Total carbohydrate determination
Total soluble protein extracted in phosphate buffered saline (PBS), acid, base and/or alcohol
PBS soluble protein analyzed on 2-Dimensional gels as a comparative standard

Field performance data on #2 yellow dent corn parental and hybrid varieties may also be collected. Average height, diseases observed and percent coverage, percent lodging, and yield may be recorded.

In addition, seed composition data and field performance data on cellulase corn may be collected to determine its fit within the normal parameters. Transgenic lines of corn that produce cellulase in the germ of the grain are available for this work. The inbred parent germplasm may be back-crossed onto the transgenic lines. Identical data may be collected for the transgenic hybrid and inbred lines. Observations of field performance may also be collected.

### 2.4 Implementing the Regulatory Plan

The plan may include a description of the necessary data and services to help a company begin the process of regulatory approval a biotechnology-derived crop. Having reviewed the literature and determined the data needed to be collected through field study or laboratory analysis, the plan may be implemented in order to work towards preparing appropriate submissions to the regulatory bodies.

### 3. Herbicide Resistant Peas for Livestock Generated Through Genetic Engineering.

In this example, a customer has a specialty crop product, more specifically, herbicide resistant peas generated through genetic engineering for livestock feed. The customer contacts the agricultural contract research organization for assistance with regulatory approval in order to move the product to market. The agricultural contract research organization requests information about the product including such information as how the product was made, what the gene is, and what the crop is. A consultation may occur between a product manager (or other person) associated with the agricultural contract research organization, and a customer. The agricultural contract research organization assists in helping the customer through the regulatory approval process. The agricultural contract research organization may provide a road map from which to make decisions about required data collection such as through use of decision trees, atlas, or otherwise. The agricultural contract research organization will assist in determining which regulatory agencies may be involved (likely the USDA and FDA for this product). The agricultural contract research organization may accompany the customer to consultations with agencies. Importantly, the agricultural contract research organization can assist the customer in determining the standard against which their crop will be compared. The agricultural contract research organization may assist the customer in collecting relevant crop data either through internal means or external contracts. The agricultural contract research organization will assist in assembling data for use in a petition or other submission to the appropriate agencies.

### 4. Insect Resistant Squash for Human Consumption Generated Through Genetic Engineering.

In this example, a customer has a specialty crop product, more specifically, insect resistant squash for human consumption generated through genetic engineering. In this example, the customer contacts an agricultural contract research organization for help with regulatory approval to move the product to market. The agricultural contract research organization requests information about the product including such information as how the product was made, what is the gene, what is the crop. A consultation may occur between a product manager (or other person) associated with the agricultural contract research organization and a customer. The agricultural contract research organization assists in helping the customer through the regulatory approval process. The agricultural contract research organization may provide a road map from which to make decisions about required data collection such as through use of decision trees, atlas, or otherwise. The agricultural contract research organization will assist in determining which regulatory agencies may be involved (likely the USDA, EPA, and FDA for this crop). The agricultural contract research organization may accompany the customer to consultations with agencies. Importantly, the agricultural contract research organization can assist the customer in determining the standard against which their crop will be compared. The agricultural contract research organization may assist the customer in collecting relevant crop data either through internal means or external contracts. The agricultural contract research organization will assist in assembling data for use in a petition or other submission to the appropriate agencies.

### 5. Example of Data Mining Analysis.

In this example, data mining from literature was performed to glean numbers describing crop characteristics for corn and peas, with greater emphasis on corn. Of course, any number of other crops may be used. These examples are merely representative. It is to further be understood that because crops share important similarities in the way traits are described, thus mining algorithms used in this example may be used for other types of crops.

Data mining of literature databases may involve abstracts and/or full-text publications, although full-text publications are preferred as they are far more likely to include the numerical data needed. A database of such literature may be built through use of a web crawler program which identifies and downloads the articles. The database of literature may include articles acquired from PubMed, Agricola, Science Direct, PubMed Central, and/or other sources.

If the articles are in HTML or PDF format, the articles may be formatted to remove HTML and PDF code so that resulting files associated with the database are cleaned and formatted into a standard or plaintext format.

Then sentences are extracted based on the presence of key words in the sentences. Examples of keywords used when identifying corn characteristics in addition to the key words “corn” and “maize” include “protein”, “oil”, and “moisture.” The sentences may also be searched for terms that describe crop characteristics (such as terms describing percent protein content). In addition, the sentences may be searched for terms that describe field characteristics (such as terms describing percent lodging). The strategy of sentence-centered information extraction is used in information extraction research and supported by biological texts by, for example, Ding et al. (2002).

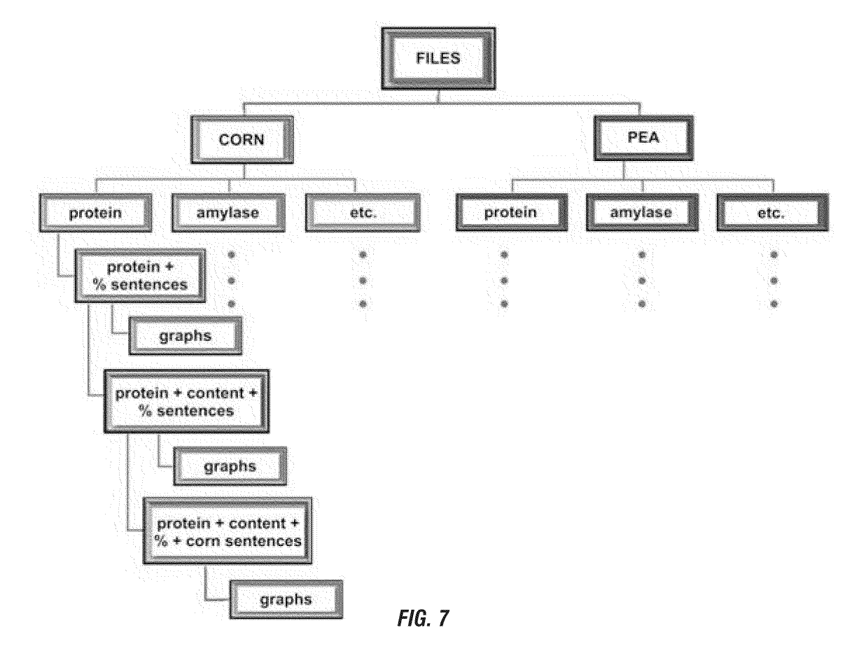

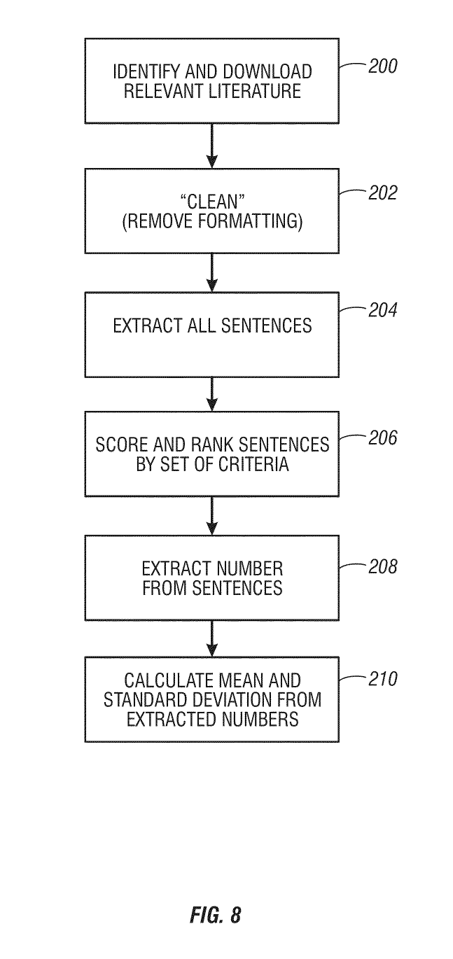

FIG. 7 illustrates one example of a file storage schema for corn and pea publications. FIG. 8 provides a block flow diagram describing the identification of relevant numerical data from the sentences in the published literature. In step 200, relevant literature is identified and downloaded. In step 202, formatting is removed from the literature. The formatting may include, although is not limited to, formatting associated with html documents or PDF files. In step 204, all sentences are extracted. Here, the sentence is the unit of analysis. In step 206, the sentences are scored and ranked by a set of criteria in a scoring algorithm. Examples of criteria may include whether the sentence describes the characteristic of interest and/or whether the sentence includes numeric values describing the characteristic(s) of interest. In step 208, a numeric value or range is extracted from the sentence. In step 210, a mean and standard deviation are calculated from the extracted numbers. It is to be understood that at this point the numbers may be manually manipulated to extract mean and standard deviation.

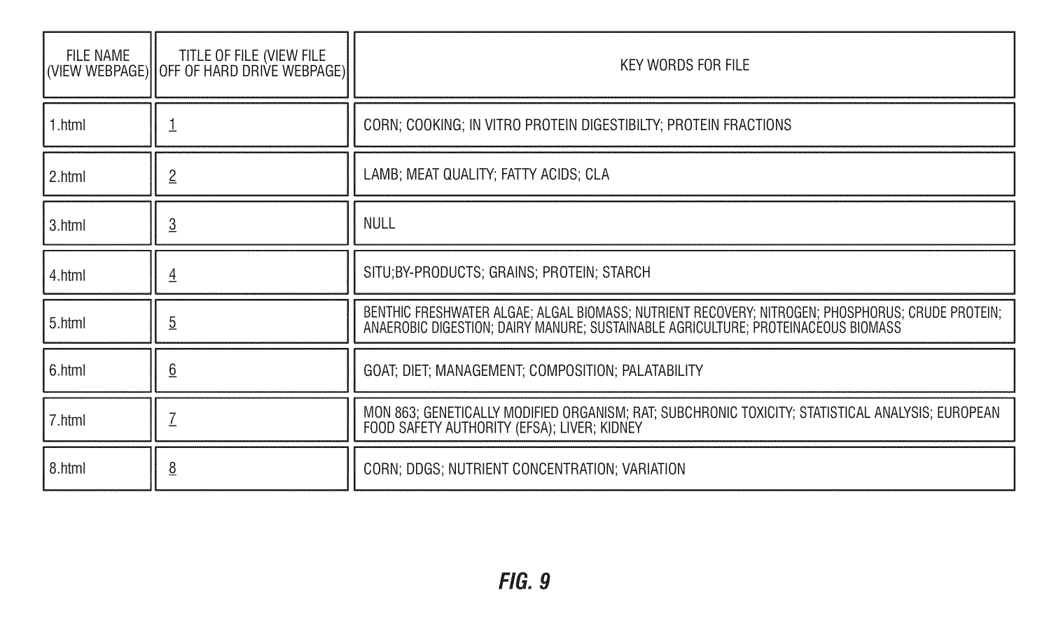

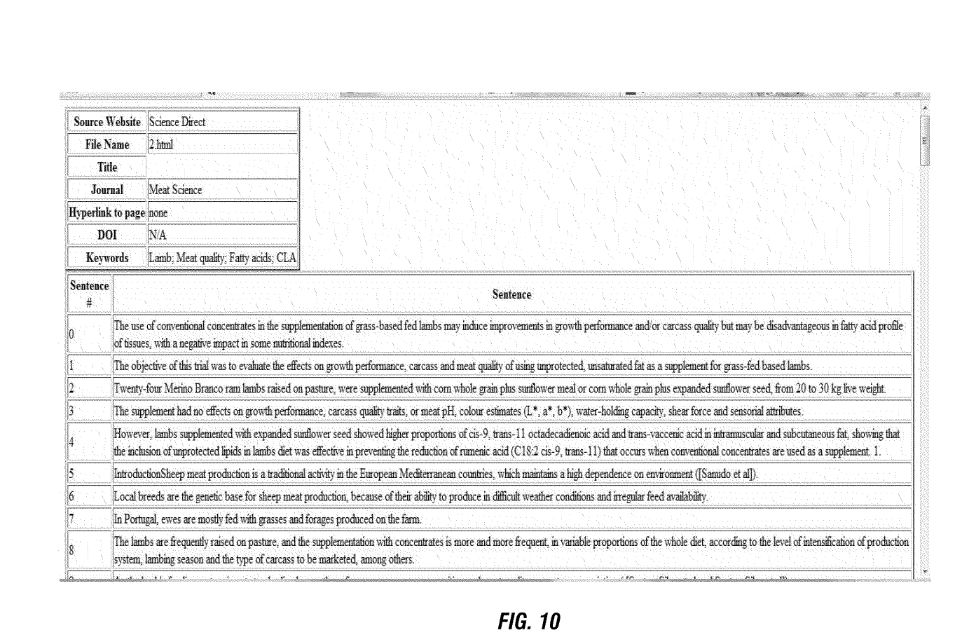

In this example, literature identified by the words “corn, maize, Zea mays” was organized into tables of contents listing files with identifiers as shown in FIG. 9. FIG. 9 is a pictorial representation of a screen shot. In the first column a link to the actual paper is provided. In the second column a link to a file listing sentences from that publication is provided as well as information about the citation. For the article stored in file 2.html, the total number of sentences was 130. FIG. 10 is a pictorial representation of a screen shot showing how sentences are pulled out.

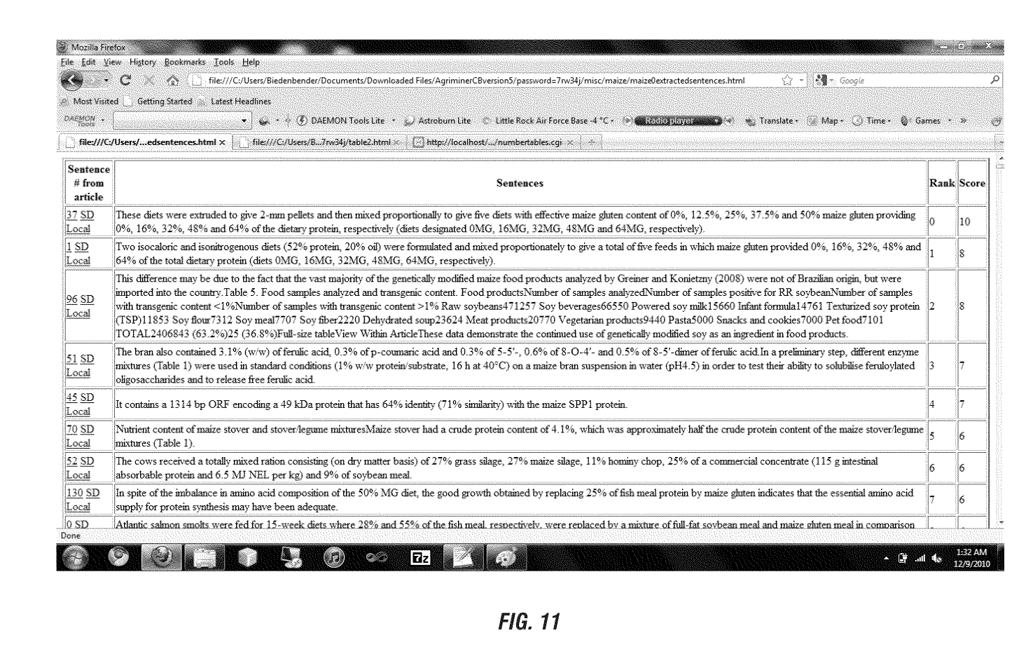

FIG. 11 illustrates one example of an algorithm for ranking sentences. In the algorithm of FIG. 11, higher scores are indicative of higher potential relevance of a sentence. Note that in the algorithm, sentences which include particular keywords or combinations of keywords or numeric values are given higher scores.

Results from applying the algorithm that show ranking and scoring are shown in FIG. 11. At the left of each sentence are three clickable hypertext links to better permit access to the context of the sentences. For example, one of these links is associated with the full text of the article, but rather than showing the beginning of the article, it shows the sentence in context. The user can then scroll up or down if desired to see preceding or succeeding material in the article.

Refinements to the methodology may be made by using feedback obtained as part of the Unified Process (UP), a software development model (IBM, 2011). Use of such a model is well-suited to projects needing step-by-step advancement in the software guided by feedback from users who are not themselves software development experts.

The algorithm produced scored and ranked sentences. Then to refine the algorithm the results were subjected to human review. From the ranked sentence list, the nine most relevant publications were identified. This enriched document set was processed by the system again. Ninety sentences were extracted, scored and ranked according to the scoring algorithm rules. Each of these sentences was then visually rated for relevance and scored manually. Six relevant sentences were manually identified as relevant and analyzed to determine why the algorithm scored them differently than the manual scoring (Table 2). The algorithm was then refined (not shown) to achieve the same result.

TABLE 2
Comparison of algorithm and manual scoring to refine algorithm

| | Score- | Score- |
|---|---|---|
| Sentence | algorithm | manual |
| Investigation showed that corn had 4.3-6.7% moisture, 1.0-2.0% ash, 1.3-2.2% crude | 8 | 7 |
| fibre, 4.9-6.2% fat, 11.3-16.9% crude protein, 74.7-81.1% carbohydrate, 256-436 mg/ | | |
| 100 g phytate, 12.6-16.9% (2 h) in vitro protein digestibility (IVPD) before cooking | | |
| and 10.4-13.7% IVPD after cooking. | | |
| After weaning, lambs were kept on pasture and received whole corn grain (10.7% of | 7 | 7 |
| crude protein; 4.2% of ether extract) and sunflower meal as a supplement (30.1% of | | |
| crude protein; 1.3% of ether extract). | | |
| These values were lower than those reported by Belyea et al. (1989) for CGF (54.0 vs. | 6 | 7 |
| 61.0), DDG (16.6 vs. 51.0), and SBH (26.4 vs. 37.0%), respectively. Tamminga et al. | | |
| (1990) reported higher crude protein A fraction values for corn and barley than we | | |
| found (15 vs. 9.6% and 25 vs. 9.4%, respectively). | | |
| Shelled corn (8% crude protein, 3.3% fat and 17% crude fiber) was fed at 0.23 kg/ | 4 | 7 |
| hd/every 2 days between initial exposure to the buck and week 17 of gestation and | | |
| 0.32 kg/hd/every 2 days from week 17 to weaning. | | |
| Residual protein for the corn lines studied ranged from 6.0 to 16.2%. | 3 | 5 |
| In addition, corn contains moderate amounts of protein (≈9 g/100 g dm). | 2 | 4 |

The relevant numbers extracted from the sentences with their range, mean and standard deviation are:

| Sentence | Number | Avg. of range | SD |
|---|---|---|---|
| 1 | 11.3-16.9 | 14.1 | |
| 2 | 10.7 | 10.7 | |
| 3 | 9.6 | 9.6 | |
| 4 | 8 | 8 | |
| 5 | 6-16.2 | 11 | |
| 6 | 9 | 9 | |
| Mean +/− SD | | 10.4 | 2.1 |

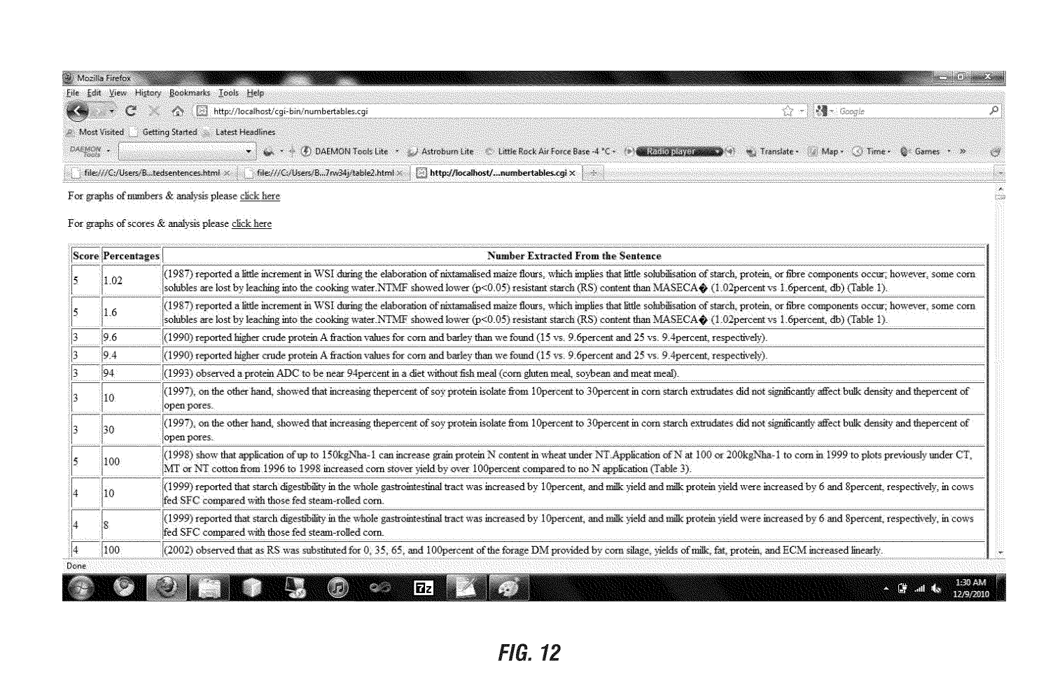

A separate algorithm was implemented to extract the numerical value from the sentence and place it in the data table of interest, to make the numbers available for further processing, such as statistical analyses like mean and standard deviation of the characteristic in question (FIG. 12). These numbers are the ultimate goal of the data mining algorithm and thus the most pertinent and valuable information.

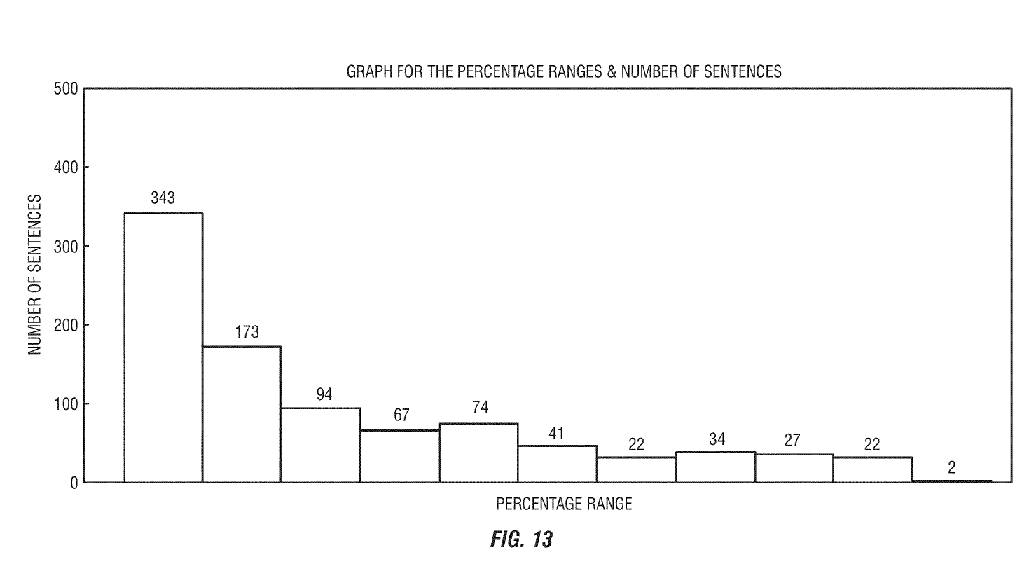

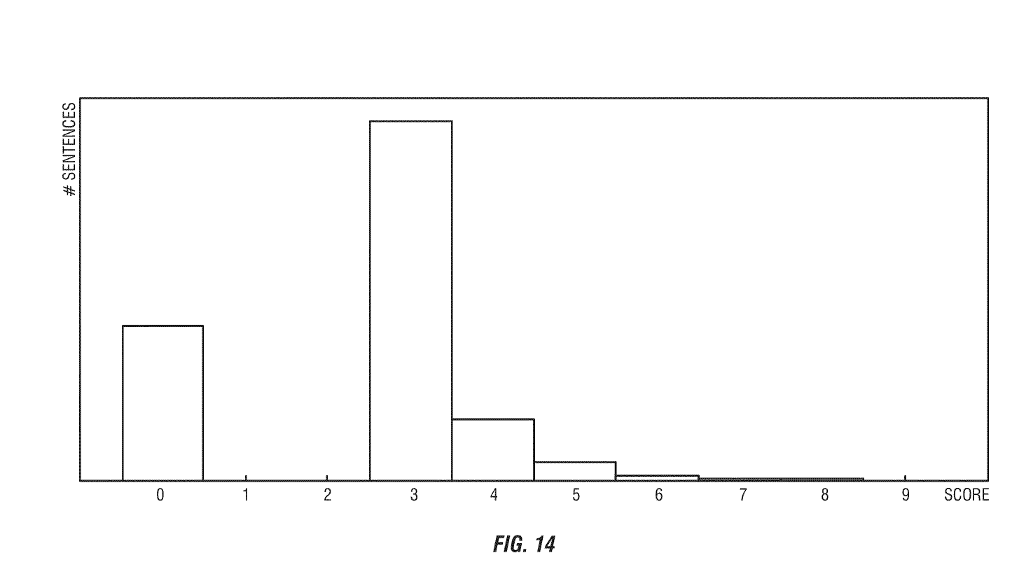

Each parameter describing a crop trait that is being studied and mined has an expected range. Thus, when analyzing the extracted numbers, they can be viewed graphically to understand the range and distribution of values. These sentences apply to the percent of protein in corn grain and the most relevant values will be between 7 and 10%. The number of sentences having each range of percentages is shown in FIG. 13. We would choose the first range (0-10%) for corn, but would peruse the second category as well. In FIG. 14, the number of sentences with each score is tallied. Because the higher the score, the better the fit with the sentence scoring criteria, sentences with scores of 5 or higher would be further analyzed.

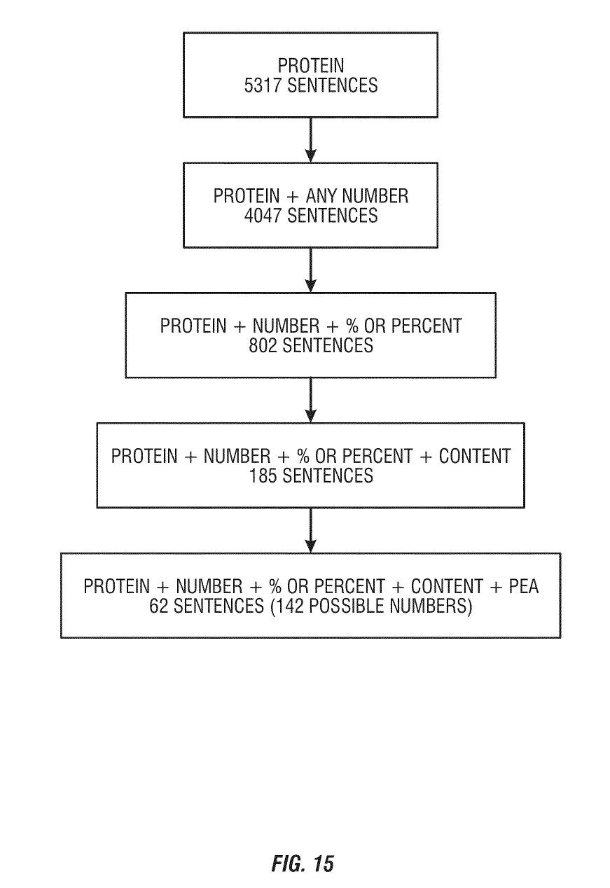

Data extraction for Pea: One hundred ninety-seven full-text articles were downloaded for peas, cleaned and parsed into sentences. The articles contained 5,317 sentences with the word protein (FIG. 15).

Using this process, 5,317 sentences related to the term “protein” from the pea-related articles were reduced to 62 sentences—exemplifying how sentence analyses proceed. The refined algorithm from the corn analyses has been applied to peas.

We have extended the sentence extraction software to also extract tables from within publications. This is a rich source of data for additional number processing because relevant compositional and descriptive data are found in tables (FIG. 16).

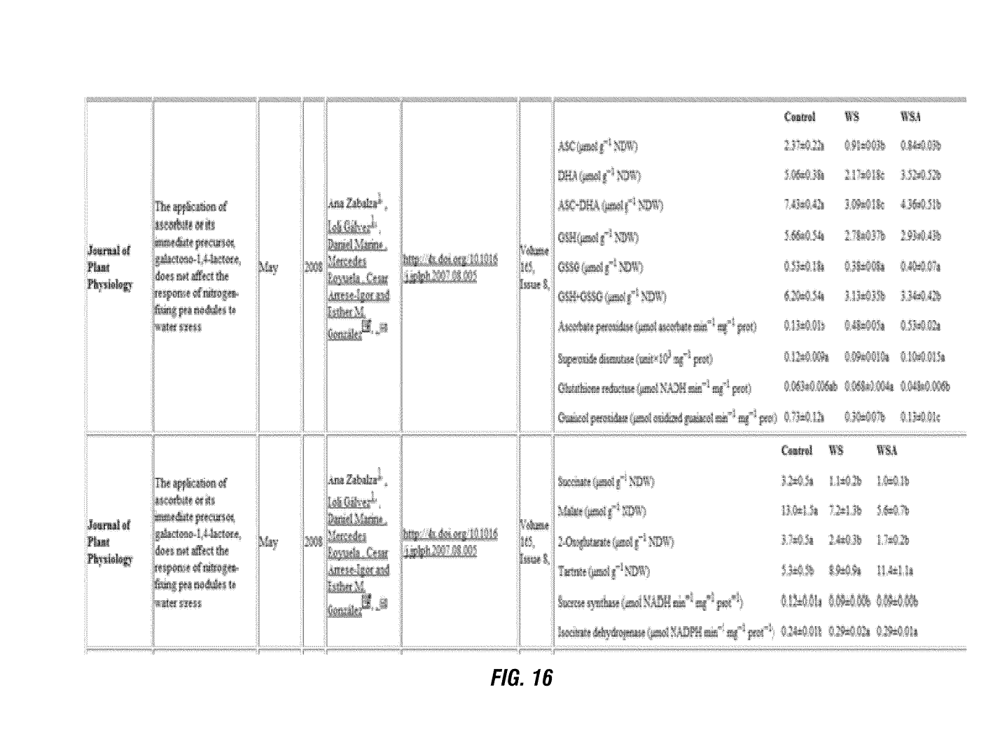

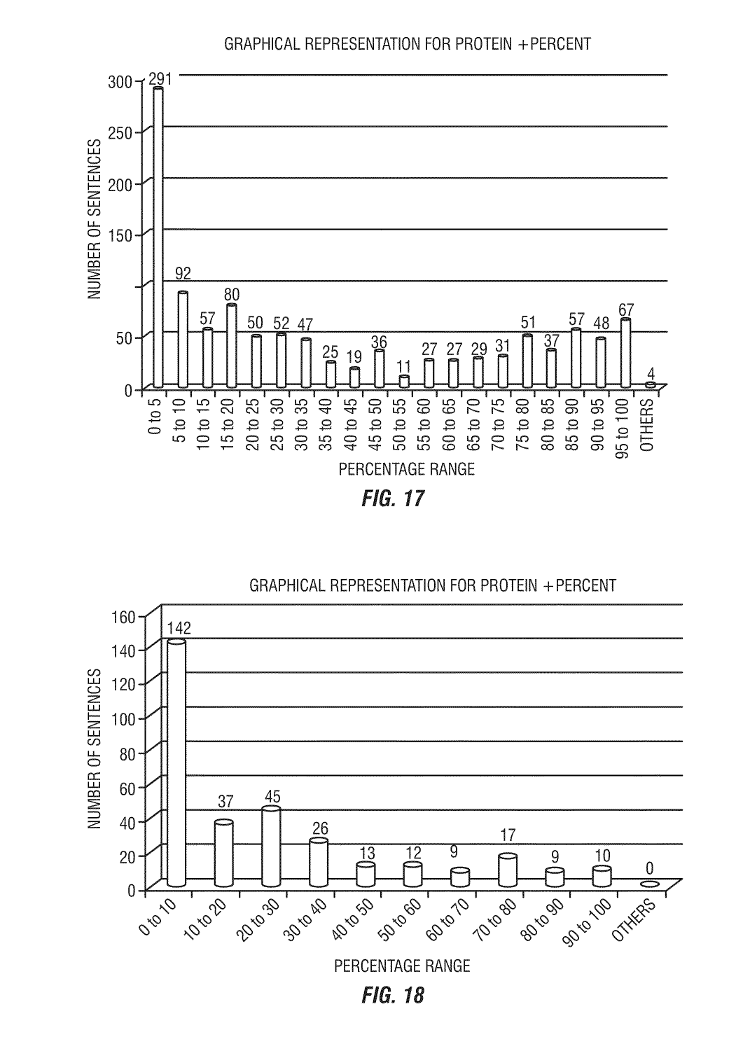

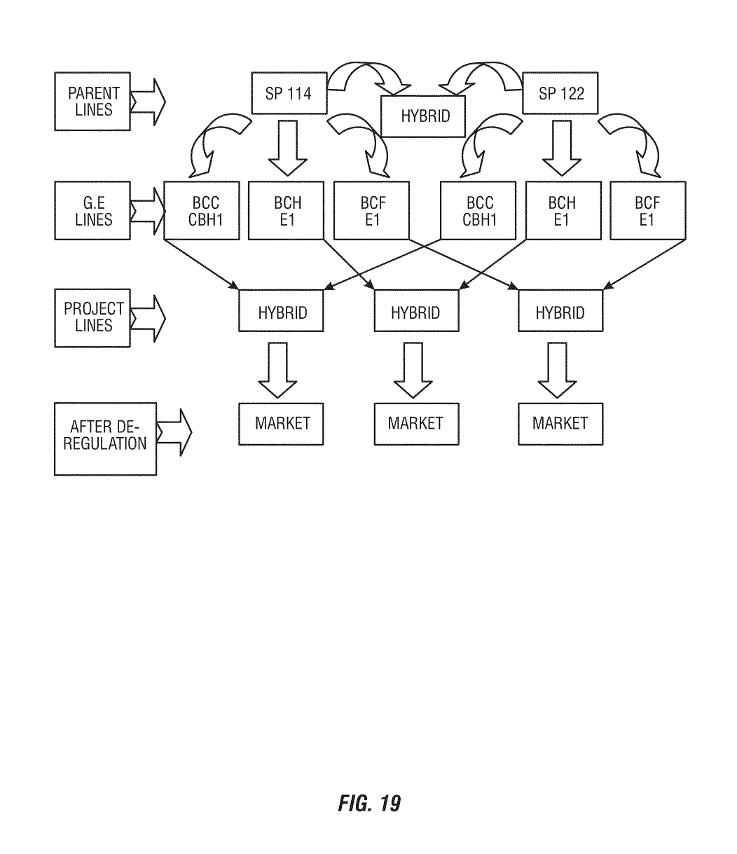

FIG. 17 and FIG. 18 validate the strategy of applying sentence scoring algorithms, text empirics (Zhang et al. 2009), information quality considerations, and database technology to more effectively identify useful information and summarize it in graphical form. Human curation will be made much more efficient and, to a significant degree, automatic extraction of information enabled.

Conditional random fields (CRFs) were investigated for use in classifying instances of numbers as relevant to percentage of protein in corn. A number that is recommended by CRF analysis would in turn indicate that the sentence containing it is likely to be relevant. For text mining applications (McDonald and Pereira 2005), CRFs normally would be applied by feeding them patterns of tags from sentences labeled as relevant or not relevant. Each sentence in this learning set would have its terms categorized and tagged with its category. New sentences are then automatically tagged and the CRF analysis checks to see if the pattern of tags for a new sentence indicates relevance. CRF analysis is an example of another form of analysis which may be used in modifying sentence scores, including in combination with the other score modifying rules already in the sentence scoring algorithm.

### Utilizing SAS Text and Data Mining Tools

SAS Text Miner is a commercially available tool that may be used for performing data mining. A preliminary test subset of full-text articles was identified in the initial searches. The terms “corn” and “amylase” (representative terms in the biotechnology literature and petitions) were clustered and linked them with other words through the SAS “Concept Linking” capability. Initially, over 6,000 words were identified by SAS as linked to corn/amylase. SAS weights the terms based in part on the extent to which they occur in proximity to the key terms in the articles. It discards words that are mentioned too often as well as words that appear only once. For remaining words, the less frequently a word appears, generally speaking, the higher its weight. This process draws on the information retrieval concept known as “inverse document frequency (IDF).”

SAS provides two types of document analysis: clustering and Concept Linking:
1) Clustering: groups related terms and reveals central themes and key concepts using Singular Value Decomposition (SVD). To perform clustering, SAS only chooses terms with the largest weights.
2) Concept Linking: studies the co-occurrences of terms to find potentially useful relationships among concepts named by the terms.

SAS acquired Teragram Corp. in 2008, and released a new type of analysis at the end of 2010: content categorization. With this functionality, SAS can be provided terms and it will then categorize sentences from the documents containing the terms. These terms can be identified, for example, using the aforementioned SAS Concept Linking functionality.

Another type of document analysis that can be performed is to use the text empirics method, developed with doctoral student Lifeng Zhang (e.g. Zhang et al., 2009; Zhang 2010). Text empirics may be applied to the problem of extracting numerical knowledge from crop science texts. FIG. 17 and FIG. 18 show the result of pulling numbers from tables of percentages into histograms showing the relative frequencies of occurrence of different numbers.

### Collection of Experimental Data

Data on seed composition and growth parameters for normal dent corn and transgenic corn expressing cellulases were collected. A summer field season (2009) was conducted to assess field performance of our model crop—corn with cellulases. Two trials at separate locations were done in Illinois by the Illinois Crop Improvement Association team. Based on the regulatory outline that we developed, data were collected on 10 characteristics of three transgenic lines compared with controls. No significant differences were observed. The grain harvested from these trials was used for laboratory analysis.

Data were collected on the following characteristics:
Seed morphology
Protein content in seed—extracted with 3 different buffers
Total seed protein, carbohydrate, mineral content and oil content—in process

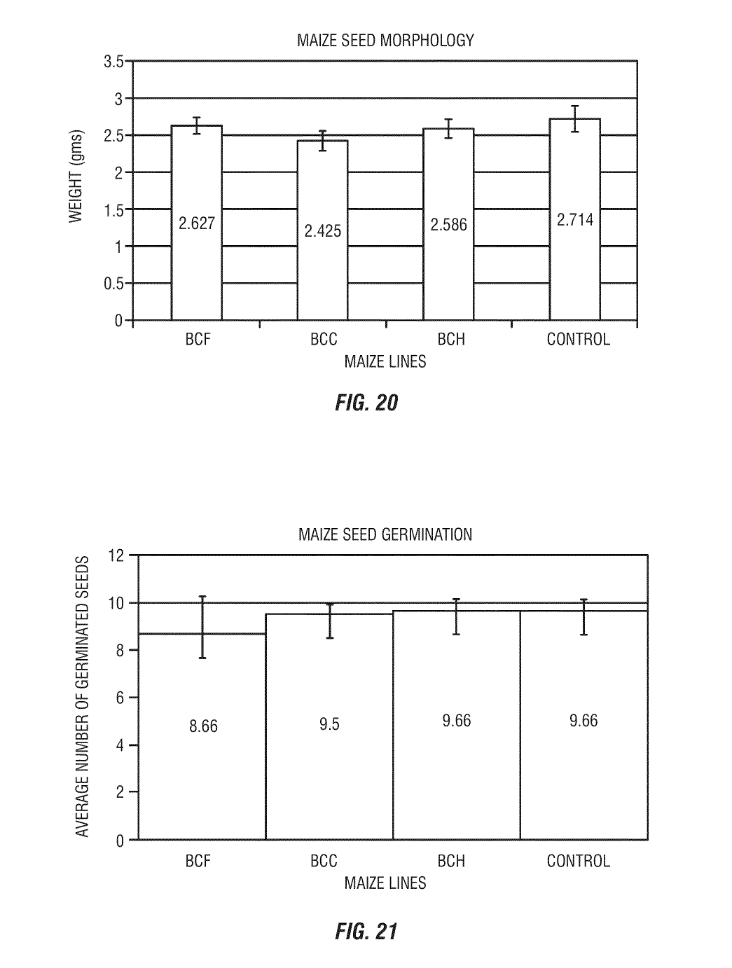

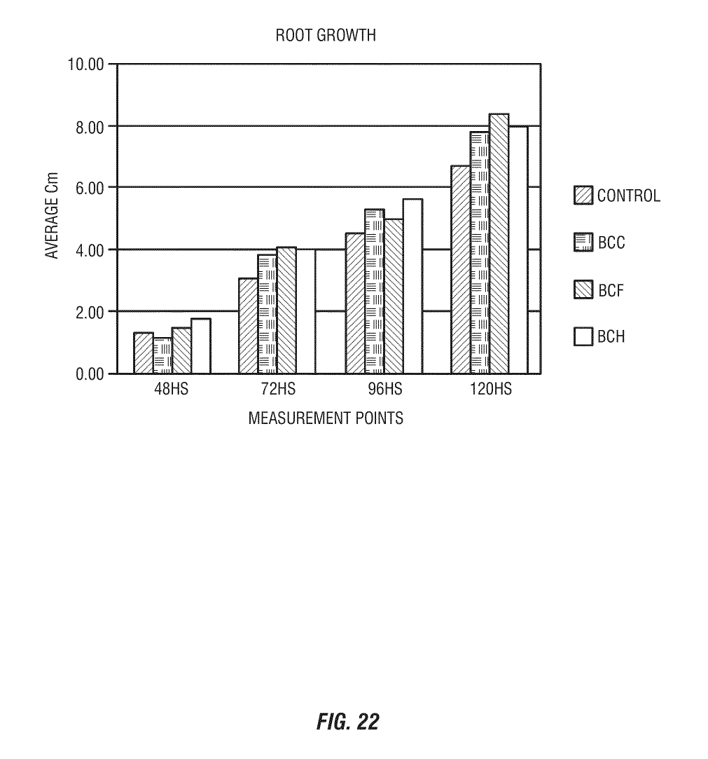

Additional observations showed no significant differences in color, size or shape of seed. FIG. 20 indicates that seed weight showed no significant differences. FIG. 21 indicates that germination showed no differences. FIG. 22 indicated that root growth showed no significant differences although control roots appeared to be less vigorous.

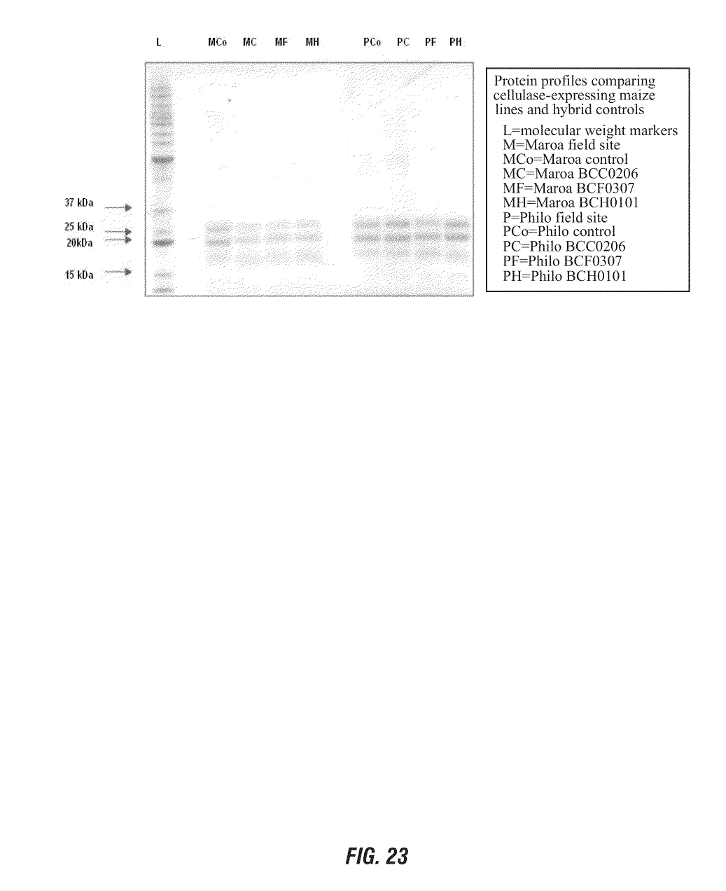

Protein comparisons were conducted on seed to assess whether changes in protein profiles were apparent. This is particularly important in this case because the transgenic trait is a protein (cellulase) accumulating in the seed. Proteins were extracted with phosphate buffered saline (PBS), ethanol (for zein storage proteins) and sodium acetate (for acidic proteins) to analyze different fractions of the seed protein. As illustrated in FIG. 23, no differences were observed among the transgenic or control lines from either field site in the ethanol soluble proteins. Other protein comparisons showed similar results.

### 6. Example of Outline of Data.

As previously explained, the present invention provides for identifying data to be collected for petitions in data mining and laboratory experiments. The below table provides an outline of data

| | | Corn Results | Control |
|---|---|---|---|
| | FORAGE Samples | | |
| 1 | Proximates | | |
| | Protein | | |
| | Fat | | |
| | Ash | | |
| | Carbohydrates | | |
| | Moisture | | |
| | Acid detergent fiber (ADF) | | |
| | Neutral detergent fiber (NDF) | | |
| 2 | Minerals | | |
| | Calcium | | |
| | Phosphorous | | |
| | GRAIN Samples | | |
| 1 | Proximates | | |
| | Protein | | |
| | Total Fat | | |
| | Ash | | |
| | Carbohydrates | | |
| | Acid detergent fiber (ADF) | | |
| | Neutral detergent fiber (NDF) | | |
| | Total dietary fiber (TDF) | | |
| 5 | Starch | | |
| 6 | Minerals | | |
| | Calcium | | |
| | Copper | | |
| | Iron | | |
| | Magnesium | | |
| | Manganese (in Syngenta petition only) | | |
| | Phosphorous | | |
| | Potassium | | |
| | Sodium | | |
| | Zinc | | |
| | Selenium | | |
| 7 | Vitamins | | |
| | Beta-carotene (provitamin A) | | |
| | Folic acid | | |
| | B1 (thiamine) | | |
| | B2 (riboflavin) | | |
| | B3 (niacin) | | |
| | B6 | | |
| | E | | |
| 8 | Fatty acids | | |
| | 16:0 palmitic | | |
| | 18:0 stearic | | |
| | 18:1 oleic | | |
| | 18:2 linoleic | | |
| | 18:3 linolenic | | |
| 9.1 | Amino acids - Essential | | |
| | Methionine | | |
| | Cysteine | | |
| | Lysine | | |
| | Tryptophan | | |
| | Threonine | | |
| | Isoleucine | | |
| | Histidine | | |
| | Valine | | |
| | Leucine | | |
| | Arginine | | |
| | Phyenylalanine | | |
| | Glycine | | |
| 9.2 | Amino acids - Non-Essential | | |
| | Alanine | | |
| | Aspartic acid | | |
| | Glutamic acid | | |
| | Proline | | |
| | Serine | | |
| | Tyrosine | | |
| 10 | Antinutrients | | |
| | Phytic acid | | |
| | Raffinose | | |
| | Trypsin inhibitor | | |
| 11 | Secondary maize metabolites | | |
| | furfural | | |
| | ferulic acid | | |
| | p-coumaric acid | | |

Purpose of Data: Proof that there are no unanticipated effects - engineered plant is unchanged from a near isogenic control except for the desired change.
Minimum site requirements: 8 sites per year in multi-year packages (at least 2 years)
Complete Data Descriptions: Data collection protocols, precision of measurements, sampling units, experimental units, and sample sizes.

| | Germination and Seedling | Scope/time | Type |
|---|---|---|---|
| 1 | Emergence Data | | |
| 1.1 | Standard lab | Varying temperature regimes | % normal germinated, abnormal |
| | germination/dormancy tests | including winter conditions | germinated, viable hard |
| | (may not be necessary for corn) | | (dormant), dead, and viable firm |
| | | | swollen seed |
| 1.1.1 | Dormancy, germination | After 4 and 7 days | % normal germinated, abnormal |
| | | | germinated, viable hard |
| | | | (dormant), dead, and viable firm |
| | | | swollen seed |
| 1.2 | Standard field emergence | | |
| | measurements | | |
| 1.2.1 | Early population | Number of plants emerged per plot | Actual count per plot |
| 1.2.2 | Seed quality & viability | Visual estimate of average vigor of | Scale from short with small |
| | (seedling vigor) | emerged plants per plot | leaves to tall with large leaves |
| 2 | Vegetative Growth | | |
| 2.1 | Final population | Pre-harvest | Number of plants |
| 2.2 | Changes in plant height | Height from the soil surface to tassel | Height in cm |
| | | tip | |
| 2.3 | Changes in ear height | Height from the soil surface to the | Height in cm |
| | | base of the primary ear | |
| 2.4 | Changes in stalk lodging | Visual estimate of percent of plants | 0 to 100% |
| | | in the plot with stalks broken below | |
| | | the primary ear | |
| 2.5 | Changes in root lodging | Visual estimate of percent of plants | 0 to 100% |
| | | in the plot leaning approximately 30 | |
| | | degrees or more in the first 2 feet | |
| | | (0.6 m) above the soil surface | |
| 2.6 | Stay Green | Overall plant health | scale - from no visible green |
| | | | tissue to very green (90% green |
| | | | tissue) |
| 3 | Reproductive Growth | | |
| 3.1 | Days to Pollen shed | from time of planting to | Number of days |
| | | approximately 50% of plants have | |
| | | tassels shedding pollen | |
| 3.1.2 | Detect changes in dispersal of | Differential dispersion | measure distances |
| | pollen | | |
| 3.2 | Change in pollen shape | shape at 50% pollen shed | percentage of pollen grains with |
| | | | collapsed walls at 0, 30, 60, & |
| | | | 120 minutes |
| 3.3 | Change in pollen color | pollen color at 50% pollen shed | percentage of pollen grains with |
| | | | intense yellow color at 0, 30, 60, |
| | | | & 120 minutes |
| 3.4 | Days to silking | from time of planting to | Number of days |
| | | approximately 50% of plants have | |
| | | emerged silks | |
| 3.5 | Pollen viability | at time of tasseling | Viable and nonviable pollen |
| | | | based on pollen grain staining |
| | | | characteristics |
| 3.6 | Pollen size | at time of tasseling | Diameter of viable pollen grains |
| 3.7 | Percent grain moisture | at harvest | percent of moisture in harvested |
| | | | shelled grain |
| 3.8 | Test weight | at harvest | Test weight in pounds of |
| | | | harvested shelled bushel of corn |
| 3.9 | Yield Data | at harvest | bushels per acre (harvest grain |
| | | | adjusted to 13% moisture |
| | | | content or another percentage for |
| | | | milling qualities) |
| 4 | Seed Retention | Dropped Ears at pre-harvest | Number of mature ears dropped |
| 5 | Plant Interactions with | From planting to harvest (differential | Qualitative assessment of each |
| | Disease | susceptibility) | plot, with 0-9 scale |
| 5.1 | Northern corn leaf blight | From planting to harvest (differential | Qualitative assessment of each |
| | | susceptibility) | plot, with 0-9 scale |
| 5.2 | Southern corn leaf blight | From planting to harvest (differential | Qualitative assessment of each |
| | | susceptibility) | plot, with 0-9 scale |
| 5.3 | Gray leaf spot rating | From planting to harvest (differential | Qualitative assessment of each |
| | | susceptibility) | plot, with 0-9 scale |
| 8 | Changes in insect | From planting to harvest - | Qualitative assessment of each |
| | susceptibilities | (differential susceptibility) - Visual | plot with rating on 0-9 scale - |
| | | estimate of insect damage | from poor insect resistance or |
| | | | high damage to best insect |
| | | | resistance or low damage |
| 8.1 | European corn borer | From planting to harvest - | Qualitative assessment of each |
| | susceptibility | (differential susceptibility) - Visual | plot with rating on 0-9 scale - |
| | | estimate of insect damage | from poor insect resistance or |
| | | | high damage to best insect |
| | | | resistance or low damage |
| 9 | Plant Interactions with | From planting to harvest - | Qualitative assessment of each |
| | Abiotic Stressors | (differential susceptibility) | plot, with 0-9 scale |

Purpose of Data: Proof that there are no unanticipated effects - engineered plant is unchanged from a near isogenic control except for the desired change. In particular, agronomic performance and phenotypic data generated demonstrate that the genetic modification did not have any unintended effects on seed germination, dormancy, plant growth habit and general morphology, life-span, vegetative vigor, flowering and pollination, grain yield, stress adaptations or disease susceptibility.
Minimum site requirements: 8 sites per year in multi-year packages (at least 2 years). Each site includes IE Corn and near isogenic, nontransgenic control hybrids.
Complete Data Descriptions: Methods of observation, resulting data, and analysis. Experimental design, use of controls, and statistical methodology. Describe sampling designs, data collection protocols, precision of measurements, sampling units, experimental units, and sample sizes.

### 7. Options, Variations, and Alternatives

Various options, variations, and alternatives have been discussed throughout. The present invention contemplates these and other options, variations, and alternatives.

It should be appreciated that different types of crops or other products which have different uses will require different data sets to support regulatory approval. Although petitions to achieve non-regulated status for each transgenic crop have data sets that have common elements, some target proteins within those crops, for example pharmaceutical proteins or industrial proteins/enzymes, require analyses that may have to be done in addition to the transgenic crop characteristic analyses. Furthermore, some crops are food crops, for example peas, beans or tomatoes, and some are non-food crops such as tobacco and alfalfa (although it is a feed). Thus, the actual plan may differ somewhat depending on the protein incorporated and the intended use. It is further appreciated that any number of types of crop (or other product) may be evaluated.

It should further be appreciated that one aspect of the present invention relates to meta-analysis. Meta-analysis may be performed in the context of the services provided to a client seeking regulatory approval of a product. In addition, meta-analysis may be performed for a regulatory body seeking insight on what data are desired to show substantial equivalence or other standards, if appropriate. The building of the database based on the literature provides a convenient platform for the meta-analysis.

As previously mentioned, it should also be appreciated that the present invention may be used for performing contract research for regulatory agencies. Examples of such research may include, without limitation, measuring gene flow, metagenomics studies examining affect on microbial or plant populations, protocol and standards development, and development of model submissions, applications, or petitions.

It should further be appreciated that the present invention may be used for providing substantiation or studies for voluntary information for regulatory agencies designed to advance or support the commercialization of a product. Examples include, without limitation, label claims and efficacy claims.

It should also be understood that the present invention may be used to assist in meeting voluntary or mandatory regulatory requirements for nanotechnology—such as a food, feed, or fiber product developed with nanoscale science, engineering, or technology.

Although various aspects and embodiments have been disclosed, the present invention is not to be limited to the specific examples shown, but rather that within the spirit and scope of the invention.

### REFERENCES

Citations to various references have been made throughout the text. A listing of such references is provided below. Each of these references is incorporated by reference in its entirety.
J. Ding, D. Berleant, D. Nettleton, and E. Wurtele, “Mining MEDLINE: abstracts, sentences, or phrases?” Pacific Symposium on Biocomputing 7 (2002), Kauai, Hawaii, Jan. 3-7, pp. 326-337. (Available at psb.stanford.edu)
E. Hood, R. Love, J. Bray, J. Lane, R. C. Clough, K. Pappu, C. Drees, K. R. Hood, S. Yoon, A. Ahmad, and J. A. Howard, Subcellular targeting is a key condition for high-level accumulation of cellulase protein in transgenic maize seed. Plant Biotechnology J; 5:709-719 (2007).
D. Hull, S. R. Petifer, and D. B. Kell. Defrosting the Digital Library: Bibliographic Tools for the Next Generation Web. PloS Computational Biologic, 4, 10. (2008)
IBM (International Business Machines) Corp., “IBM Rational Unified Process,” http://www-01.ibm.com/software/awdtools/rup/ (retrieved 1/9/11).
R. McDonald and F. Pereira; Identifying Gene and Protein Mentions in Text Using Conditional Random Fields; BMC Bioinformatics 6 S6 (2005) http://www.biomedcentral.com/1471-2105/6/S1/S6
J. Parmarthi; Extracting Properties of Crops from Web Data for Deregulation using ProExTrac”, M.S. Thesis, Department of Computer Science, University of Arkansas at Little Rock, December 2010.
P. R. Shewry, M. Baudo, A. Lovegrove, S. Powers, J. A. Napier, J. L. Wad, J. M. Baker, and M. H. Beale. Are GM and conventionally bred cereals really different? Trends in Food Science and Technology 18, 201-209 (2007).
Woodfield, Terry, Text Mining Using SAS Software Course Notes, SAS Institute Inc., Cary, N.C., 2003.
L. Zhang, PathBinder: Text Mining for Systems Biology and MetNet, dissertation, Dept. of Electrical and Computer Engineering, Iowa State University, December, 2010.
L. Zhang, D. Berleant, J. Ding, T. Cao, and E. S. Wurtele, “PathBinder—text empirics and automatic extraction of biomolecular interactions,” BMC Bioinformatics, 10 (suppl 11)(2009):S18, doi:10.1186/1471-2105-10-S11-S18.

What is claimed is:

1. A method for providing a service to assist in obtaining regulatory approval of a product, the method comprising:
using a computing device programmed to search at least one database of literature and programmed to identify data relative to determining substantial equivalence for the product to provide a first data set;
determining experimental data to collect for the product based in part on the first data set;
collecting the experimental data for the product to provide a second data set;
documenting comparative data comprising comparisons between the first data set and the second data set data indicative of substantial equivalence for the product.

2. The method of claim 1 further comprising preparing a submission for a regulatory body, the submission comprising the comparative data.

3. The method of claim 2 wherein the regulatory body is selected from a set consisting of an environmental regulatory agency, a food and drug regulatory agency, and an agricultural regulatory agency.

4. The method of claim 1 wherein the product is a crop product.

5. The method of claim 4 wherein the crop product is selected from a set consisting of a corn product, a soybean product, and a cotton product. Is this too restrictive to name these 3 crops and no others?

6. The method of claim 4 wherein the crop product is a transgenic crop product.

7. The method of claim 6 wherein the transgenic crop product is a transgenic corn product.

8. The method of claim 4 wherein the crop product is a genetically engineered specialty crop product.

9. The method of claim 1 wherein the product comprises a plant-made pharmaceutical.

10. The method of claim 1 wherein the product comprises plant-made industrial proteins.

11. The method of claim 1 wherein the product comprises a nanotechnology product.

12. The method of claim 1 further comprising performing a meta-analysis using the data.

13. The method of claim 1 wherein the determining experimental data to collect for the product comprises using results of a meta-analysis.

14. The method of claim 1 further comprising determining experimental data to collect for one or more controls.

15. A method for providing a service to assist in obtaining regulatory approval of a product, the method comprising:
providing a web site stored on a web server, the web site providing for secure access to clients;
receiving at the web site information about a product that a client seeks to obtain regulatory approval for;
using a computing device programmed to search at least one database of literature and programmed to identify data relative to determining substantial equivalence for the product to provide a first data set;
receiving at the web site the experimental data for the product to provide a second data set;
generating comparative data by making comparisons between the first data set and the second data set data indicative of substantial equivalence for the product; and
compiling a document comprising data for submission to a regulatory body using the comparative data.

16. The method of claim 15 wherein the document is a draft petition.

17. The method of claim 15 wherein the product is a crop product.

18. The method of claim 17 wherein the crop product is a genetically engineered specialty crop product.

19. The method of claim 15 wherein the product is a nanotechnology product.

20. The method of claim 15 further comprising making available the document on the web site.

21. A method for providing a service to assist in scientific documentation of at least one product, the method comprising:
using a computing device programmed to search at least one database of literature and programmed to identify data relative to determining substantial equivalence for the at least one product to provide a first data set;
determining experimental data to collect for the at least one product based in part on the first data set;
collecting the experimental data for the at least one product to provide a second data set;
documenting comparative data comprising comparisons between the first data set and the second data set data indicative of substantial equivalence for the at least one product to provide the scientific documentation.

22. The method of claim 21 further comprising preparing a petition for regulatory approval using the scientific documentation.

23. The method of claim 21 wherein the scientific documentation provides for advancing or supporting commercialization of the at least one product.

24. The method of claim 21 wherein the service is provided to a regulatory body.
